(19) United States
(12) Patent Application Publication
(10) Pub. No.: US 2026/0070337 A1
(43) Pub. Date: Mar. 12, 2026

(54) LIQUID EJECTION APPARATUS

(71) Applicant: SEIKO EPSON CORPORATION, Tokyo (JP)

(72) Inventor: Ryosuke FUJII, SHIOJIRI-SHI (JP)

(21) Appl. No.: 19/317,689

(22) Filed: Sep. 3, 2025

(30) Foreign Application Priority Data
Sep. 6, 2024 (JP) 2024-153634

(51) Int. Cl. B41J 2/165

(52) U.S. Cl. CPC B41J 2/16514; B41J 2/16544

(57) ABSTRACT

A liquid ejection apparatus includes a head having a nozzle surface in which a plurality of nozzles that eject a liquid are opened, a carriage that moves along first direction intersecting vertical direction while supporting the head, a cap that covers the nozzle surface, and a moving unit that moves the cap along the vertical direction between a cap position at which the cap covers the nozzle surface and a separated position at which the cap is separated from the nozzle surface, wherein the moving unit is operable by an operator from a front side along second direction intersecting the vertical direction and the first direction.

The present application is based on, and claims priority from JP Application Serial Number 2024-153634, filed Sep. 6, 2024, the disclosure of which is hereby incorporated by reference herein in its entirety.

### BACKGROUND

### 1. Technical Field

The present disclosure relates to a liquid ejection apparatus.

### 2. Related Art

For example, as in JP-A-2013-154587, a recording apparatus including a recording head that ejects a liquid is disclosed. The recording apparatus as an example of a liquid ejection apparatus is provided with a cap that seals the nozzles of the recording head and a cap lifting unit that raises and lowers the cap. The cap lifting unit as an example of a moving unit can move the cap to a raised position where the cap performs capping and a lowered position where the cap does not perform capping.

The cap lifting unit includes a horizontal shaft portion extending in the left-right direction when viewed from the front, and a cam plate fixed to the horizontal shaft portion. The horizontal shaft portion rotates with the cam plate in contact with the lower surface of the cap, and thus the cam plate can raise the cap.

JP-A-2013-154587 is an example of the related art.

However, in the liquid ejection apparatus, when an operator adjusts the moving unit, it is necessary to operate the moving unit from a side of the apparatus to which the horizontal shaft portion extends. Accordingly, it is necessary to secure a work space at the lateral side of the apparatus. Therefore, it is desired to improve the convenience of the operator.

### SUMMARY

A liquid ejection apparatus according to an aspect of the present disclosure includes a head having a nozzle surface in which a plurality of nozzles that eject a liquid are opened, a carriage that moves along first direction intersecting vertical direction while supporting the head, a cap that covers the nozzle surface, and a moving unit that moves the cap along the vertical direction between a cap position at which the cap covers the nozzle surface and a separated position at which the cap is separated from the nozzle surface, wherein the moving unit is operable by an operator from a front side along second direction intersecting the vertical direction and the first direction.

### BRIEF DESCRIPTION OF THE DRAWINGS

FIG. 1 is a perspective view showing a liquid ejection apparatus according to a first embodiment.

FIG. 2 is a top view showing the liquid ejection apparatus of the first embodiment.

FIG. 3 is a perspective view showing the liquid ejection apparatus of the first embodiment.

FIG. 4 is a perspective view showing the liquid ejection apparatus of the first embodiment.

FIG. 5 is a front view showing a medium support section of the first embodiment.

FIG. 6 is a perspective view showing the medium support section of the first embodiment.

FIG. 7 is a perspective view showing a rotation shaft and a moving unit of the first embodiment.

FIG. 8 is a perspective view showing the rotation shaft and the moving unit of the first embodiment.

FIG. 9 is a front view showing a medium support section according to a second embodiment.

### DESCRIPTION OF EMBODIMENTS

### First Embodiment

Hereinafter, an embodiment of a liquid ejection apparatus will be described with reference to the drawings. In the following description, direction intersecting the vertical direction Z are defined as width direction X and direction intersecting the vertical direction Z and the width direction X are defined as front-rear direction Y. One of the width direction X is referred to as a first width direction X1 and the other of the width direction X is referred to as a second width direction X2. One of the front-rear direction Y is referred to as a frontward direction Y1 and the other of the front-rear direction Y is referred to as a rearward direction Y2. The upward direction of the vertical direction Z is referred to as an upward direction Z1, and the downward direction of the vertical direction Z is referred to as a downward direction Z2. The width direction X correspond to an example of first direction, and the front-rear direction Y correspond to an example of second direction.

### Configuration of Liquid Ejection Apparatus 11

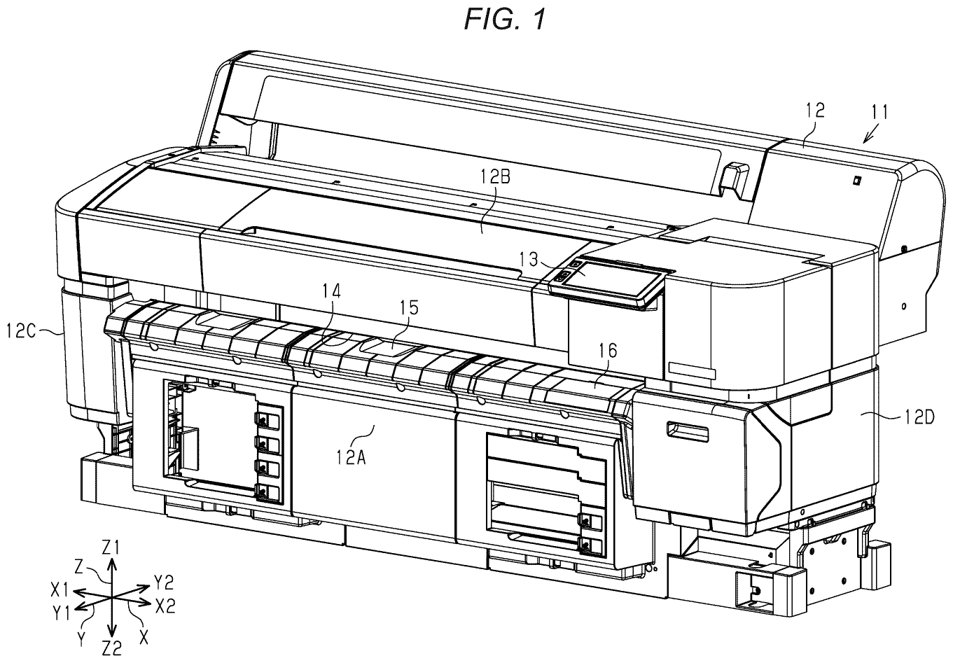

A liquid ejection apparatus 11 is configured to perform printing on a medium by ejecting a liquid onto the medium as shown in FIG. 1. The liquid may include, for example, ink. The liquid may have, for example, a plurality of colors. The liquid ejection apparatus 11 may be an inkjet printer.

The liquid ejection apparatus 11 includes a housing 12. The housing 12 is configured to house various members forming the liquid ejection apparatus 11. The housing 12 is configured as an exterior of the liquid ejection apparatus 11. The housing 12 may be supported by leg portions (not illustrated).

The housing 12 includes a front surface 12A. The front surface 12A is a surface in the frontward direction Y1 of the housing 12. The housing 12 includes a top surface 12B. The top surface 12B is a surface in the upward direction Z1 of the housing 12.

The housing 12 includes a first side surface 12C and a second side surface 12D. The first side surface 12C is a surface of the housing 12 in the first width direction X1. The second side surface 12D is a surface of the housing 12 in the second width direction X2. The first side surface 12C and the second side surface 12D are surfaces including the vertical direction Z and the front-rear direction Y.

As described above, the liquid ejection apparatus 11 can be disposed such that the first side surface 12C or the second side surface 12D is in contact with a wall. The liquid ejection apparatus 11 is an apparatus intended for access from the front surface 12A side. The liquid ejection apparatus 11 may be disposed in contact with a wall on the back surface (not illustrated). Here, the expression “disposed in contact with” includes the liquid ejection apparatus 11 disposed with a gap between the liquid ejection apparatus 11 and the wall such that an operator cannot enter.

The liquid ejection apparatus 11 includes an operation panel 13. The operation panel 13 is provided on the top surface 12B. The operation panel 13 is provided at the side in the frontward direction Y1 of the top surface 12B. The operation panel 13 includes an operation unit that can be operated by a user. The operation panel 13 includes a display unit that displays various types of information. The operation panel 13 may be a touch panel provided on the display unit.

The liquid ejection apparatus 11 includes an ejection opening 14 and a medium support section 15. The ejection opening 14 is an opening for ejecting the medium after printing. The ejection opening 14 is provided in the front surface 12A. The ejection opening 14 is provided to extend in the width direction X.

The medium support section 15 is provided on the front surface 12A. The medium support section 15 may be configured to extend from the front surface 12A in the rearward direction Y2. The medium support section 15 may be configured to protrude from the front surface 12A in the frontward direction Y1. The medium support section 15 is provided to extend in the width direction X.

The medium support section 15 is configured to support the medium ejected from the ejection opening 14. The medium ejected from the ejection opening 14 is a medium onto which a liquid is ejected. As described above, the medium support section 15 is configured to support the medium onto which the liquid is ejected.

The liquid ejection apparatus 11 includes a cover 16. The cover 16 is detachably provided in the frontward direction Y1 of the medium support section 15. The cover 16 is provided at an end portion of the medium support section 15 in the second width direction X2.

### Regions of Liquid Ejection Apparatus 11

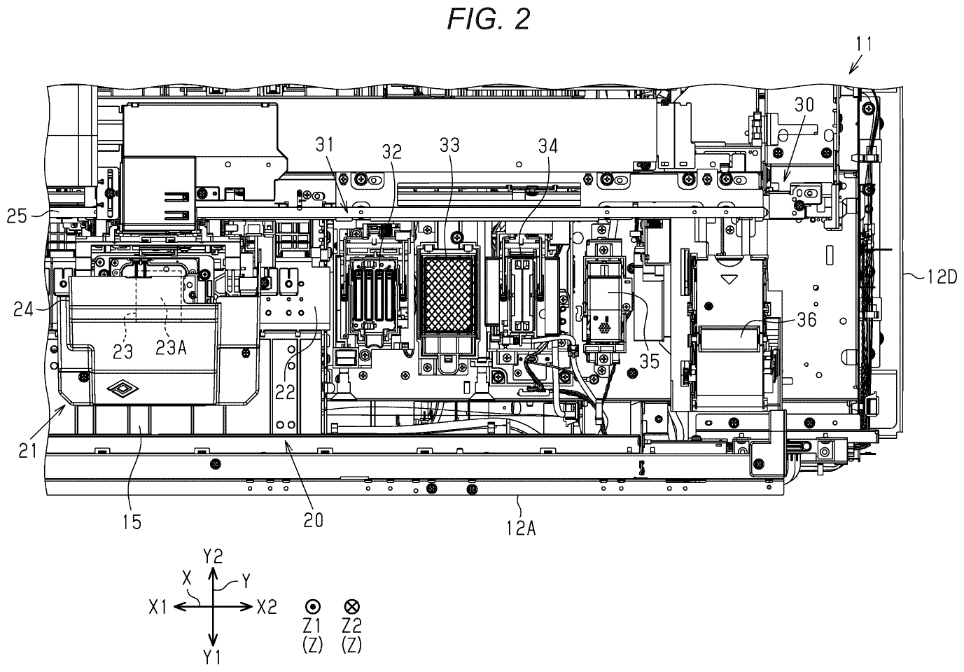

As illustrated in FIG. 2, the liquid ejection apparatus 11 includes a printing region 20 and a maintenance region 30. The printing region 20 is a region for performing printing on the medium. The maintenance region 30 is a region for performing maintenance of the head 23 described later.

The printing region 20 is provided at the center of the liquid ejection apparatus 11. The maintenance region 30 is provided in the second width direction X2 with respect to the center of the liquid ejection apparatus 11. That is, the maintenance region 30 is provided in the second width direction X2 with respect to the printing region 20.

### Configuration of Liquid Ejection Portion 21

The liquid ejection apparatus 11 includes a liquid ejection portion 21 and a support portion 22. The liquid ejection apparatus 11 includes a conveyance portion (not illustrated). The conveyance portion is configured to convey the medium. The conveyance portion is configured to convey the medium toward the frontward direction Y1 in the printing region 20.

The liquid ejection portion 21 is configured to eject the liquid onto the medium. The liquid ejection portion 21 is configured to eject the liquid onto a region of the medium supported by the support portion 22 in the printing region 20. The liquid ejection portion 21 is configured to eject the liquid onto the medium conveyed in the frontward direction Y1 in the printing region 20.

The liquid ejection portion 21 includes the head 23, a carriage 24, and a carriage guide 25. That is, the liquid ejection apparatus 11 includes the head 23, the carriage 24, and the carriage guide 25.

The head 23 is configured to eject the liquid. The head 23 of the present embodiment ejects the liquid toward the downward direction Z2. The head 23 is configured to be supported by a bottom surface of the carriage 24.

The head 23 includes a nozzle surface 23A. The nozzle surface 23A is a surface in which a plurality of nozzles (not illustrated) that eject the liquid are opened. The nozzle surface 23A is provided on the bottom surface of the head 23 so as to face the downward direction Z2. The head 23 is configured to eject the liquid from the plurality of nozzles.

The carriage 24 is configured to support the head 23. The carriage 24 is supported by the carriage guide 25. The carriage guide 25 is configured to extend in the width direction X. The carriage guide 25 is configured to extend in the width direction X over the printing region 20 and the maintenance region 30. The carriage 24 is configured to reciprocate in the width direction X along the carriage guide 25 by a driving force from a carriage drive portion (not illustrated).

Accordingly, the carriage 24 is configured to move along the width direction X while supporting the head 23. The carriage 24 is configured to move along the width direction X in the printing region 20 and the maintenance region 30.

The carriage 24 passes through a position facing the medium supported by the support portion 22 by reciprocating along the width direction X in the printing region 20. The head 23 is configured to eject the liquid in the printing region 20 along the width direction X. The head 23 prints an image on the medium by ejecting the liquid onto the medium.

The support portion 22 is configured to support the medium. The support portion 22 is provided to extend in the width direction X in the printing region 20. The support portion 22 is configured to support the medium conveyed by the conveyance portion in the printing region 20. The support portion 22 is provided at a position facing the head 23 in the printing region 20.

### Configuration of Maintenance Unit 31

The liquid ejection apparatus 11 includes the maintenance unit 31. The maintenance unit 31 is provided in the maintenance region 30. The maintenance unit 31 is provided at a position facing the head 23 in the maintenance region 30. The maintenance unit 31 is configured to perform maintenance of the head 23.

The maintenance unit 31 includes a moisturizing cap 32, a flushing portion 33, a suction cap 34, a deairing portion 35, and a wiping portion 36. In the maintenance region 30, the moisturizing cap 32, the flushing portion 33, the suction cap 34, the deairing portion 35, and the wiping portion 36 are disposed in order in the second width direction X2.

The moisturizing cap 32 is provided at a position facing the head 23 in the maintenance region 30. The moisturizing cap 32 is located on the first width direction X1 side with respect to the suction cap 34 in the width direction X.

The moisturizing cap 32 comes into contact with the head 23 to form a space that communicates with the nozzles. The moisturizing cap 32 caps the head 23 by coming into close contact with the head 23. The moisturizing cap 32 moisturizes the nozzles by capping the head 23. That is, the moisturizing cap 32 is a cap that moisturizes the head 23, for example, in the vicinity of the plurality of nozzles by covering the nozzle surface 23A while facing the head 23.

The moisturizing cap 32 can be moved to a second cap position and a second separated position along the vertical direction Z by the operation of a second moving unit 52 described later. The second cap position is a position where the moisturizing cap 32 covers the nozzle surface 23A with the moisturizing cap 32 facing the head 23. The second separation position is a position where the moisturizing cap 32 is separated from the nozzle surface 23A with the moisturizing cap 32 facing the head 23.

The flushing portion 33 is provided at a position facing the head 23 in the maintenance region 30. The flushing portion 33 is located on the second width direction X2 side at the outer side of the moisturizing cap 32 in the width direction X. The flushing portion 33 is located on the first width direction X1 side as the inner side than the suction cap 34 in the width direction X.

The flushing portion 33 is configured to receive the liquid ejected from the head 23. The flushing portion 33 may receive the liquid ejected from the head 23 by pressurization. That is, the flushing portion 33 may receive the liquid ejected by pressurized cleaning.

The pressurized cleaning ejects the liquid from inside of the head 23 by pressurizing the liquid within the head 23. The pressurized cleaning is maintenance for forcibly ejecting the liquid from the nozzles to eject air bubbles, foreign substances, and the like from the nozzles along with the liquid within the head 23.

The flushing portion 33 may receive the liquid ejected by dummy ejection. The dummy ejection is an operation of ejecting the liquid from the nozzles to suppress clogging of the nozzles. The dummy ejection is also referred to as flushing. The dummy ejection, for example, ejects a liquid having increased viscosity from the nozzles. The flushing portion 33 receives the liquid ejected from the head 23 facing the flushing portion 33.

The suction cap 34 is provided at a position facing the head 23 in the maintenance region 30. The suction cap 34 is located on the second width direction X2 side with respect to the moisturizing cap 32 in the width direction X. In FIG. 2, the suction cap 34 is covered by a cap cover, but the cap cover is removed during actual use. As a result, the suction cap 34 is opened.

The suction cap 34 comes into contact with the head 23 to form a space that communicates with the nozzles. The suction cap 34 caps the head 23 by coming into close contact with the head 23. The suction cap 34 suctions the liquid from the head 23 by suction using a suction pump (not illustrated) while capping the nozzle surface 23A. That is, the suction cap 34 is a cap that suctions the liquid from the head 23 while facing the head 23 and covering the nozzle surface 23A.

As described above, by suctioning the inside of the space communicating with the plurality of nozzles formed by the suction cap 34 and the head 23 coming into contact with each other, the inside of the space communicating with the plurality of nozzles is set at negative pressure, whereby the suction cleaning of the head 23 is performed. When the suction cleaning is performed on the head 23 not filled with the liquid, the head 23 can be filled with the liquid. When the suction cleaning is performed on the head 23 filled with the liquid, air bubbles, foreign substances, and the like in the head 23 can be ejected. As described above, the suction cap 34 is configured to receive the liquid ejected from the head 23 along with the suction cleaning.

The suction cap 34 is movable to a first cap position and a first separated position along the vertical direction Z by operation of a first moving unit 51 described later. The first cap position is a position where the suction cap 34 covers the nozzle surface 23A with the suction cap 34 facing the head 23. The first separation position is a position where the suction cap 34 is separated from the nozzle surface 23A with the suction cap 34 facing the head 23.

The deairing portion 35 is provided at a position facing the head 23 in the maintenance region 30. The deairing portion 35 is located on the second width direction X2 side with respect to the moisturizing cap 32 and the suction cap 34 in the width direction X. The deairing portion 35 is configured to deair the head 23 or a path for supplying the liquid to the head 23. The deairing portion 35 may remove air bubbles or the like contained in the liquid from the head 23 or the path for supplying the liquid to the head 23.

The wiping portion 36 is configured to wipe the liquid from the head 23. The wiping portion 36 is configured to wipe the nozzle surface 23A at a position facing the head 23. The wiping portion 36 performs maintenance of the head 23 by wiping a waste liquid from the nozzle surface 23A.

The wiping portion 36 performs wiping to wipe the nozzle surface 23A. The wiping portion 36 may be movable in the front-rear direction Y. The wiping portion 36 may wipe the nozzle surface 23A by moving in the front-rear direction Y. The wiping portion 36 is located on the second width direction X2 side with respect to the moisturizing cap 32 and the suction cap 34 in the width direction X.

### Cap Position Adjustment

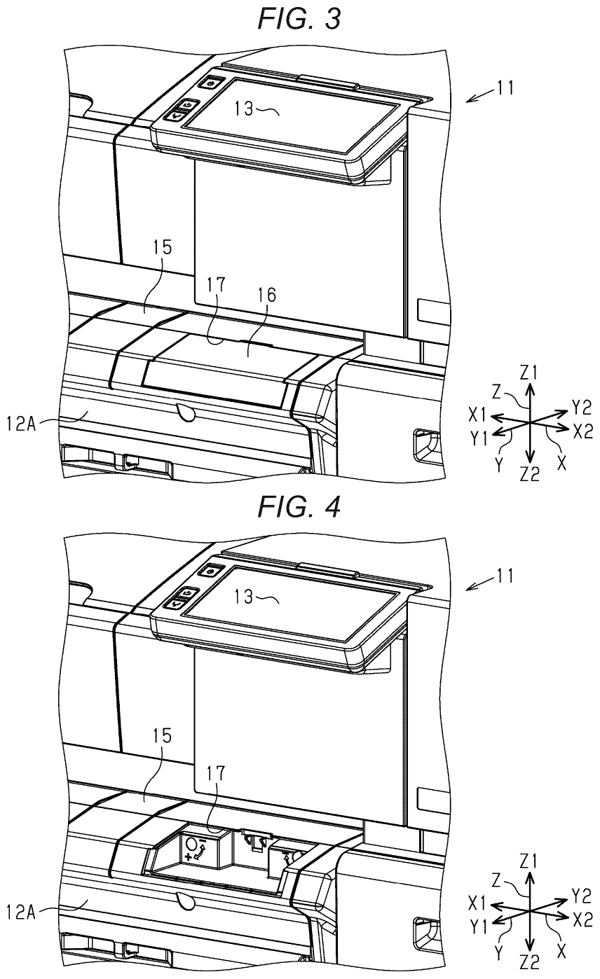

Here, the position adjustment of the moisturizing cap 32 and the suction cap 34 will be described in detail with reference to FIGS. 3 to 8. Hereinafter, at least one of the moisturizing cap 32 and the suction cap 34 may be simply referred to as a cap. The position adjustment of the cap is an operation of adjusting the position of the cap in the vertical direction Z, for example, when the power is off and when an error occurs.

As illustrated in FIG. 3, when the cover 16 is attached to the medium support section 15, an operation region 17 is not exposed. That is, the cover 16 is configured to be attached to the medium support section 15 to cover a part of the medium support section 15. Thus, the operation region 17 is covered.

As illustrated in FIG. 4, the operator may manually adjust the position of the cap. In such a case, the cover 16 is detached from the medium support section 15. As a result, the operation region 17 is exposed. The operation region 17 is a region for performing position adjustment of the moisturizing cap 32 and the suction cap 34.

The medium support section 15 includes the operation region 17. The operation region 17 is provided on a front surface 15A of the medium support section 15. In the operation region 17, a recess may be formed in the front surface 15A of the medium support section 15. The operation region 17 is accessible from the front surface 12A side by the operator.

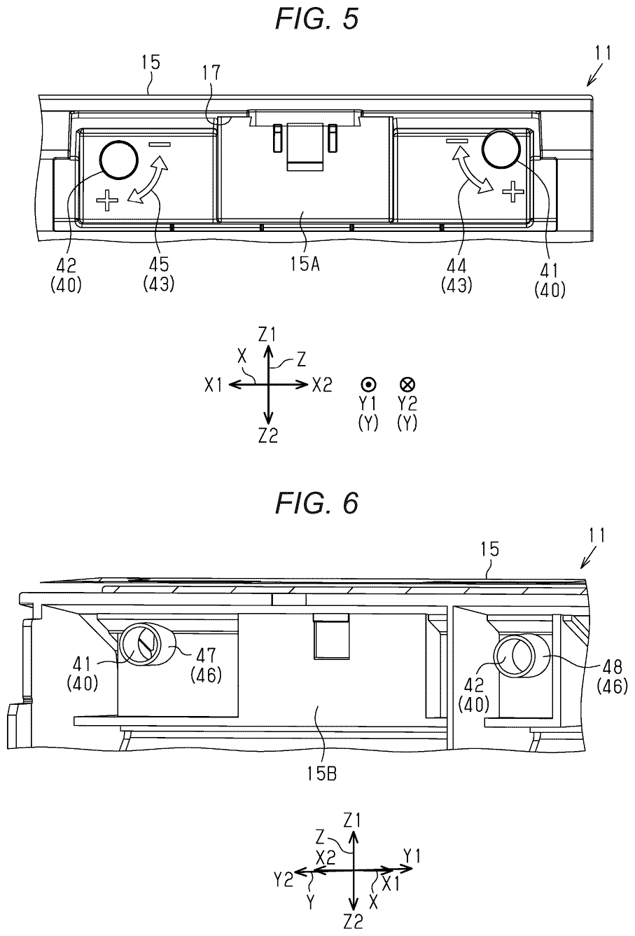

As illustrated in FIG. 5, the medium support section 15 includes one or more insertion holes 40. The insertion hole 40 is a hole penetrating the medium support section 15 in the front-rear direction Y. The insertion hole 40 has a circular shape, but is not limited thereto. The insertion hole 40 is a hole for adjusting the position of the cap. The insertion hole 40 is a hole through which a tool is inserted to adjust the position of the cap. The tool may be, for example, a screwdriver.

The medium support section 15 may include a first insertion hole 41 and a second insertion hole 42 as one or more insertion holes 40. The first insertion hole 41 is a hole for adjusting the position of the suction cap 34. The second insertion hole 42 is a hole for adjusting the position of the moisturizing cap 32.

The insertion hole 40 is covered by the cover 16 by attaching the cover 16 to the medium support section 15. The insertion hole 40 is exposed by detaching the cover 16 from the medium support section 15.

The medium support section 15 includes one or more operation display units 43. The operation display unit 43 is provided on the front surface 15A of the medium support section 15. The operation display unit 43 is provided at a position corresponding to the insertion hole 40. The operation display unit 43 can be visually recognized by the operator from the side in the frontward direction Y1 of the liquid ejection apparatus 11.

The operation display unit 43 indicates an operation direction for adjusting the position of the cap. The operation display unit 43 includes a rising image and a falling image. The rising image indicates an operation direction in which the cap rises. The falling image indicates an operation direction in which the cap falls. The rising image may be, for example, a plus image. The falling image may be, for example, a minus image.

The medium support section 15 may include a first operation display unit 44 and a second operation display unit 45 as one or more operation display units 43. The first operation display unit 44 is provided at a position corresponding to the first insertion hole 41. The second operation display unit 45 is provided at a position corresponding to the second insertion hole 42.

As illustrated in FIG. 6, the medium support section 15 includes one or more guide tubes 46. The guide tube 46 is provided on a back surface 15B of the medium support section 15. The guide tube 46 is configured to extend from the back surface 15B of the medium support section 15 in the rearward direction Y2. The inner diameter of the guide tube 46 may decrease toward the rearward direction Y2. The guide tube 46 is configured to communicate with the insertion hole 40 at the end portion in the frontward direction Y1. The guide tube 46 is configured to guide the tool inserted into the insertion hole 40 from the frontward direction Y1 to the rearward direction Y2.

The medium support section 15 may include a first guide tube 47 and a second guide tube 48 as one or more guide tubes 46. The first guide tube 47 is provided to communicate with the first insertion hole 41. The second guide tube 48 is provided to communicate with the second insertion hole 42.

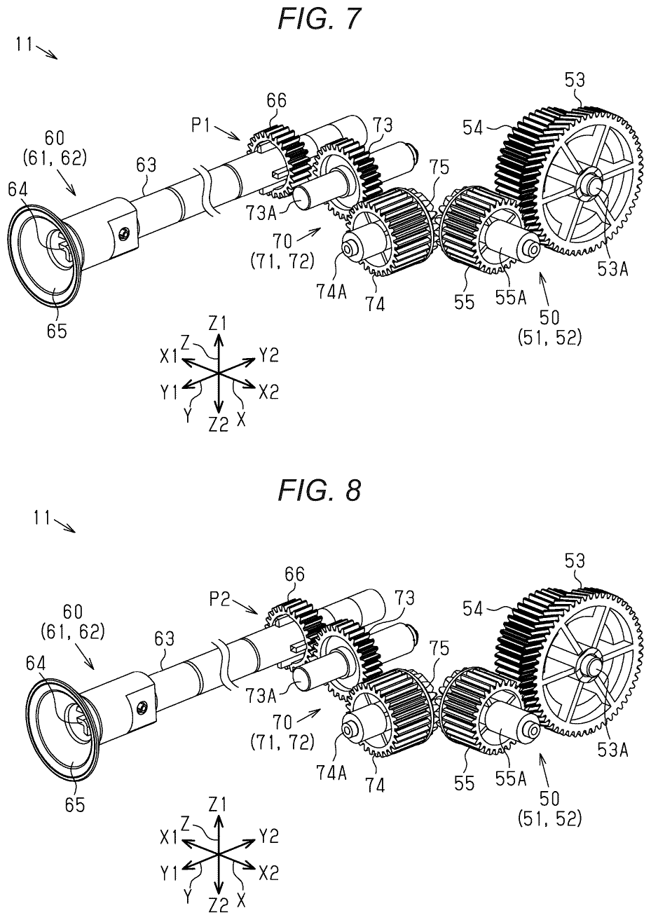

As illustrated in FIG. 7, the liquid ejection apparatus 11 includes one or more moving units 50, one or more operation shafts 60, and one or more power transmission units 70. The moving unit 50 is a mechanism for moving the cap along the vertical direction Z. Specifically, the moving unit 50 moves the cap to the cap position and the separated position along the vertical direction Z.

The moving unit 50 includes a drive gear 53. The drive gear 53 is a gear for raising and lowering the cap. The drive gear 53 is rotatable about a drive shaft 53A. The drive shaft 53A extends in the width direction X. The drive gear 53 may be a gear that rotates a cam for raising and lowering the cap.

The moving unit 50 includes gears 54 and 55. The gear 54 is rotatably attached to the drive shaft 53A. The gear 54 is provided so as to mesh with the gear 55. The gear 55 is rotatable about a rotation shaft 55A. The gear 55 may be coupled to a lifting drive source (not illustrated) for raising and lowering the cap. The lifting drive source may be a motor. Thus, as the gear 55 rotates, the power of the gear 55 is transmitted to the drive gear 53 via the gear 54. Accordingly, the cap is raised and lowered.

The liquid ejection apparatus 11 may include a first moving unit 51 and the second moving unit 52 as one or more moving units 50. The first moving unit 51 moves the suction cap 34 to the first cap position and the first separated position along the vertical direction Z. The second moving unit 52 moves the moisturizing cap 32 to the second cap position and the second separated position along the vertical direction Z.

The operation shaft 60 is provided in the rearward direction Y2 of the insertion hole 40. The operation shaft 60 is provided in the rearward direction Y2 of the guide tube 46. The operation shaft 60 is provided to extend along the front-rear direction Y. The operation shaft 60 is rotatable about an axis along the front-rear direction Y. The operation shaft 60 is a mechanism for manually moving the cap along the vertical direction Z according to an operation by the operator.

The operation shaft 60 includes a shaft portion 63, a drive portion 64, a guide portion 65, and an operation gear 66. The shaft portion 63 is provided to extend along the front-rear direction Y. The drive portion 64, the guide portion 65, and the operation gear 66 are rotatably attached to the shaft portion 63.

The drive portion 64 is provided at an end portion of the operation shaft 60 in the frontward direction Y1. The drive portion 64 is located in the rearward direction Y2 of the insertion hole 40. The drive portion 64 is located in the rearward direction Y2 of the guide tube 46. The drive portion 64 may be, for example, a hole for inserting a tool. The drive portion 64 transmits the driving force from the tool to the operation shaft 60 when the tool is inserted therein.

The guide portion 65 is provided at an end portion of the operation shaft 60 in the frontward direction Y1. The guide portion 65 has a tubular shape. The inner diameter of the guide portion 65 may decrease toward the rearward direction Y2. The guide portion 65 is located in the rearward direction Y2 of the insertion hole 40. The guide portion 65 is located in the rearward direction Y2 of the guide tube 46.

An end portion of the guide portion 65 on the frontward direction Y1 side is open. The guide portion 65 communicates with the drive portion 64 at an end portion on the rearward direction Y2 side. The guide portion 65 guides the tool inserted through the insertion hole 40 and the guide tube 46 to the drive portion 64.

The operation gear 66 is provided on the rearward direction Y2 side of the operation shaft 60. The operation gear 66 is rotatably attached to the shaft portion 63. The operation gear 66 rotates according to the driving force from the tool. The operation gear 66 is a gear for transmitting power to the power transmission unit 70.

As described above, by opening the cover 16, the operator can operate the operation shaft 60 from the frontward direction Y1 via the insertion hole 40, the guide tube 46, the guide portion 65, and the drive portion 64.

The liquid ejection apparatus 11 may include a first operation shaft 61 and a second operation shaft 62 as one or more operation shafts 60. The first operation shaft 61 is a mechanism for manually moving the suction cap 34 along the vertical direction Z according to the operation by the operator. The second operation shaft 62 is a mechanism for manually moving the moisturizing cap 32 along the vertical direction Z according to the operation by the operator.

The power transmission unit 70 is a mechanism for transmitting the power of the operation shaft 60 to the moving unit 50. The power transmission unit 70 includes gears 73 and 74 and a bevel gear 75. The gear 73 is rotatable about a rotation shaft 73A. The rotation shaft 73A is provided to extend in the front-rear direction Y. The gear 74 is rotatable about a rotation shaft 74A. The rotation shaft 74A is provided to extend in the front-rear direction Y. The gear 74 meshes with the gear 73.

The bevel gear 75 is rotatably attached to the rotation shaft 74A. The bevel gear 75 is rotatable about the rotation shaft 74A. The bevel gear 75 meshes with the gear 55. The bevel gear 75 transmits power for rotation about the rotation shaft 74A as power for rotation about the rotation shaft 55A.

The liquid ejection apparatus 11 may include a first power transmission unit 71 and a second power transmission unit 72 as one or more power transmission units 70. The first power transmission unit 71 is a mechanism for transmitting the power of the first operation shaft 61 to the first moving unit 51. The second power transmission unit 72 is a mechanism for transmitting the power of the second operation shaft 62 to the second moving unit 52.

The operation shaft 60 is movable in the front-rear direction Y. The operation shaft 60 is movable to an initial position P1 shown in FIG. 7 and a transmission position P2 shown in FIG. 8. The initial position P1 is a position where the operation gear 66 does not mesh with the gear 73. The initial position P1 is a position where the operation gear 66 is disposed in the frontward direction Y1 with respect to the gear 73 in the front-rear direction Y. The transmission position P2 is a position where the operation gear 66 meshes with the gear 73.

The operation shaft 60 is disposed at the initial position P1 by an urging force from an urging portion (not illustrated). The operation shaft 60 moves from the initial position P1 to the transmission position P2 against the urging force from the urging portion (not illustrated) by being pushed from the frontward direction Y1 to the rearward direction Y2.

The operation shaft 60 may be disposed at the initial position P1 by coming into contact with a first contact portion (not illustrated) by the urging force from the urging portion (not illustrated). The operation shaft 60 may be disposed at the transmission position P2 by being pushed from the frontward direction Y1 to the rearward direction Y2 and coming into contact with a second contact portion (not illustrated) against the urging force from the urging portion (not illustrated).

Thus, the operation shaft 60 can be engaged with the moving unit 50 via the power transmission unit 70. That is, the moving unit 50 can be operated by the operator from the frontward direction Y1. In particular, the operation shaft 60 can be engaged with the moving unit 50 when pushed from the frontward direction Y1 to the rearward direction Y2.

### Functions and Effects of First Embodiment

Functions and effects of the first embodiment will be described.
(1-1) The moving unit 50 moves the cap to the cap position and the separated position along the vertical direction Z. The moving unit 50 can be operated from the frontward direction Y1 of the liquid ejection apparatus 11. According to the configuration, it is not necessary to secure a work space at the lateral side of the liquid ejection apparatus 11, and the operator can operate the moving unit 50 from the frontward direction Y1 of the liquid ejection apparatus 11. Therefore, the convenience of the operator can be improved.
(1-2) The operation shaft 60 extends along the front-rear direction Y, is operable by the operator from the frontward direction Y1, and is engageable with the moving unit 50. According to the configuration, even when the moving unit 50 is disposed at a position away from the frontward direction Y1 of the liquid ejection apparatus 11, the operator can operate the moving unit 50 from the frontward direction Y1 of the liquid ejection apparatus 11 by using the operation shaft 60 extending along the front-rear direction Y. Therefore, the convenience of the operator can be improved.
(1-3) The operation shaft 60 can be operated by the operator by opening the cover 16 that covers a part of the medium support section 15. According to the configuration, the operator can operate the moving unit 50 from the frontward direction Y1 of the liquid ejection apparatus 11 by opening the cover 16. In addition, the cover 16 is not opened in a situation in which the moving unit 50 is not operated, and thus the design of the liquid ejection apparatus 11 can be improved and mixing of foreign substances into the liquid ejection apparatus 11 can be suppressed.
(1-4) When the cover 16 is attached to the medium support section 15, the insertion hole 40 is covered by the cover 16. The operation shaft 60 can be operated by the operator from the frontward direction Y1 of the liquid ejection apparatus 11 via the insertion hole 40. According to the configuration, the operator can operate the moving unit 50 via the insertion hole 40 from the frontward direction Y1 of the liquid ejection apparatus 11 by opening the cover 16. In addition, even in a situation in which the moving unit 50 is operated, although the insertion hole 40 is formed in the medium support section 15, mixing of foreign substances into the liquid ejection apparatus 11 can be suppressed by the medium support section 15.
(1-5) The operation shaft 60 can be engaged with the moving unit 50 when pushed from the frontward direction Y1 to the rearward direction Y2. According to the configuration, the operator can operate the moving unit 50 from the frontward direction Y1 of the liquid ejection apparatus 11 by performing the pushing operation the operation shaft 60 toward the rearward direction Y2 from the frontward direction Y1. Further, erroneous operation by the operator can be suppressed. Therefore, the convenience of the operator can be improved. In addition, when the moving unit 50 is not operated, the power load on the moving unit 50 can be reduced.
(1-6) The liquid ejection apparatus 11 includes the first moving unit 51 that moves the suction cap 34 to the first cap position and the first separated position along the vertical direction Z, and the second moving unit 52 that moves the moisturizing cap 32 to the second cap position and the second separated position along the vertical direction Z. The first moving unit 51 and the second moving unit 52 can be operated by the operator from the frontward direction Y1 of the liquid ejection apparatus 11. According to the configuration, it is not necessary to secure a work space at the lateral side of the liquid ejection apparatus 11, and the operator can operate both the first moving unit 51 and the second moving unit 52 from the frontward direction Y1 of the liquid ejection apparatus 11. Therefore, the convenience of the operator can be improved.
(1-7) The wiping portion 36 is located on the second width direction X2 side of the cap in the width direction X. According to the configuration, even when the wiping portion 36 is located on the second width direction X2 side of the cap in the width direction X, the operator can operate the moving unit 50 from the frontward direction Y1 of the liquid ejection apparatus 11. Therefore, the convenience of the operator can be improved.

### Second Embodiment

Next, a second embodiment will be described. In the following description, the overlapping description of the same configurations as those of the embodiment described above will be omitted or simplified, and configurations different from those of the embodiment described above will be described.

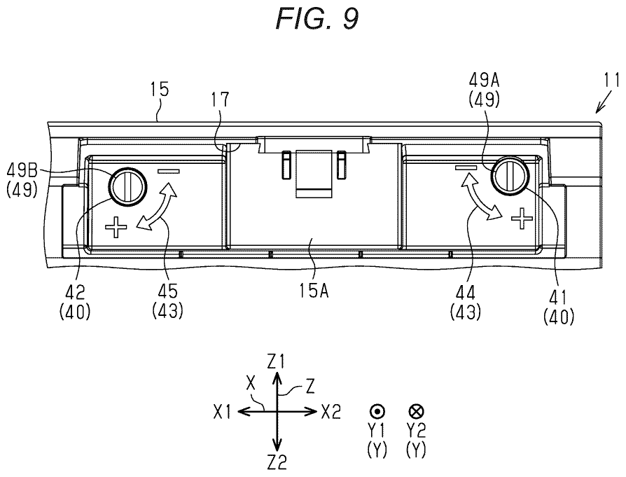

As illustrated in FIG. 9, in the second embodiment, the liquid ejection apparatus 11 may include one or more knobs 49. The knob 49 is inserted into the insertion hole 40 and held. The knob 49 can be operated by the operator. The knob 49 is turnable when being inserted into the insertion hole 40.

The knob 49 is provided to extend in the front-rear direction Y. The knob 49 is configured such that the rear end portion in the rearward direction Y2 engages with the operation shaft 60. Specifically, the knob 49 is configured such that the rear end portion in the rearward direction Y2 engages with the drive portion 64. The knob 49 may be configured such that the rear end portion in the rearward direction Y2 engages with the drive portion 64 via the insertion hole 40 and the guide tube 46. The knob 49 may be movable in the front-rear direction Y. Thus, the operation shaft 60 can be operated by the operator turning the knob 49. When the cover 16 is attached to the medium support section 15, the knob 49 is covered by the cover 16. The knob 49 may be directly coupled to the shaft portion 63.

The liquid ejection apparatus 11 may include a first knob 49A and a second knob 49B as one or more knobs 49. The first knob 49A is a member for operating the first moving unit 51 by pivoting the first operation shaft 61. The second knob 49B is a member for operating the second moving unit 52 by pivoting the second operation shaft 62.

### Functions and Effects of Second Embodiment

Functions and effects of the second embodiment will be described.
(2-1) The knob 49 is turnable when being inserted into the insertion hole 40. The operation shaft 60 can be operated by the operator by turning the knob 49. When the cover 16 is attached to the medium support section 15, the knob 49 is covered by the cover 16. According to the configuration, by opening the cover 16, the operator can operate the moving unit 50 using the knob 49 via the insertion hole 40 from the frontward direction Y1 of the liquid ejection apparatus 11. Accordingly, the moving unit 50 can be operated without using a tool separately from the knob 49. Therefore, the convenience of the operator can be improved.

### MODIFICATION EXAMPLES

The present embodiments can be implemented with the modifications described below. The present embodiment and the following modification examples can be implemented in combination with each other as long as no technical inconsistencies are involved.

The cover 16 may be provided to be openable and closable when being supported by the medium support section 15. The cover 16 may be provided to be openable and closable by rotating with respect to the medium support section 15. The cover 16 may be provided to be openable and closable by sliding in a predetermined direction with respect to the medium support section 15.

The operation region 17 is provided in a region of the front surface 15A of the medium support section 15 where the ejection opening 14 is not provided in the width direction X, but may be provided in a region where the ejection opening 14 is provided in the width direction X. The operation region 17 may be provided in another region such as the front surface 12A of the housing 12 instead of the medium support section 15. As described above, the operation region 17 may be provided in a region accessible from the front surface 12A side by the operator.

The maintenance region 30 may be provided in the first width direction X1 with respect to the center of the liquid ejection apparatus 11. That is, the maintenance area 30 may be provided in the first width direction X1 with respect to the printing region 20.

The moving unit 50 may include the bevel gear 75, and the power transmission unit 70 may not include the bevel gear 75. The moving unit 50, the operation shaft 60, and the power transmission unit 70 may be configured to rotate about the same direction. In this case, the moving unit 50 and the power transmission unit 70 may not include the bevel gear 75.

The lifting drive source may be a drive source that rotates any one of the drive shaft 53A and the rotation shafts 73A and 74A instead of the rotation shaft 55A. The lifting drive source may be a drive source that rotates a rotation shaft other than the drive shaft 53A and the rotation shafts 55A, 73A, and 74A. The moving unit 50 may include the lifting drive source.

In the maintenance unit 31, the moisturizing cap 32, the flushing portion 33, the suction cap 34, the deairing portion 35, and the wiping portion 36 may be disposed in any order in the second width direction X2 in the maintenance region 30. The maintenance unit 31 may not include any of the moisturizing cap 32, the flushing portion 33, the suction cap 34, the deairing portion 35, and the wiping portion 36.

The medium may be a sheet of paper, a film or a sheet made of resin, a film made of a composite of resin and metal, a laminate film, a woven fabric, a nonwoven fabric, metal foil, a metal film, a ceramic sheet, clothing, or the like.

The liquid can be optionally selected as long as the liquid can perform printing on the medium by adhering to the medium. For example, the ink includes ink in which particles of a functional material including a solid matter such as a pigment or a metal particle are dissolved, dispersed, or mixed in a solvent and includes various compositions such as aqueous ink, oil-based ink, gel ink, and hot melt ink.

The expression “at least one of” used in the present specification means one or more of desired choices. As an example, the expression “at least one of” used in the present specification means only one choice or both of two choices when the number of choices is two. As another example, the expression “at least one of” used in the present specification means only one choice or a combination of any two or more choices when the number of the choices is three or more.

### APPENDICES

Technical ideas understood from the embodiments and the modified examples described above and the functions and effects thereof will hereinafter be described. The technical ideas and the functions and effects thereof can be combined with each other as long as no technical inconsistencies are involved.
[1] A liquid ejection apparatus includes a head having a nozzle surface in which a plurality of nozzles that eject a liquid are opened, a carriage that moves along first direction intersecting vertical direction while supporting the head, a cap that covers the nozzle surface, and a moving unit that moves the cap along the vertical direction between a cap position at which the cap covers the nozzle surface and a separated position at which the cap is separated from the nozzle surface, wherein the moving unit is operable by an operator from a front side along second direction intersecting the vertical direction and the first direction.

According to the configuration, it is not necessary to secure a work space at the lateral side of the liquid ejection apparatus, and the operator can operate the moving unit from the front side of the liquid ejection apparatus. Therefore, the convenience of the operator can be improved.
[2] The liquid ejection apparatus further includes an operation shaft extending along the second direction, wherein the operation shaft may be operable by the operator from the front side and may be engageable with the moving unit.

According to the configuration, even when the moving unit is disposed at a position away from the front side of the liquid ejection apparatus, the operator can operate the moving unit from the front side of the liquid ejection apparatus by using the operation shaft extending along the second direction. Therefore, the convenience of the operator can be improved.
[3] The liquid ejection apparatus further includes a medium support section that supports a medium onto which the liquid is ejected from the head, and a cover that covers a part of the medium support section, wherein the operation shaft may be operable by the operator by opening the cover.

According to the configuration, the operator can operate the moving unit from the front side of the liquid ejection apparatus by opening the cover. In addition, the cover is not opened in a situation in which the moving unit is not operated, and thus the design of the liquid ejection apparatus can be improved and mixing of foreign substances into the liquid ejection apparatus can be suppressed.
[4] In the liquid ejection apparatus, the medium support section may have an insertion hole, the insertion hole may be covered by the cover, and the operation shaft may be operable by the operator from the front side via the insertion hole.

According to the configuration, the operator can operate the moving unit via the insertion hole from the front side of the liquid ejection apparatus by opening the cover. In addition, even in a situation in which the moving unit is operated, although the insertion hole is formed in the medium support section, mixing of foreign substances into the liquid ejection apparatus can be suppressed by the medium support section.
[5] The liquid ejection apparatus further includes a knob engaged with the operation shaft, wherein the medium support section may have an insertion hole, the knob may be turnable when being inserted into the insertion hole, the knob may be covered by the cover, and the operation shaft may be operable by the operator by turning the knob.

According to the configuration, by opening the cover, the operator can operate the moving unit using the knob from the front side of the liquid ejection apparatus via the insertion hole. Accordingly, the moving unit can be operated without using a tool separately from the knob. Therefore, the convenience of the operator can be improved. In addition, even in a situation in which the moving unit is operated, although the insertion hole is formed in the medium support section, mixing of foreign substances into the liquid ejection apparatus can be suppressed by the medium support section.
[6] In the liquid ejection apparatus, the operation shaft may be engageable with the moving unit when pushed toward a rear side from the front side.

According to the configuration, the operator can operate the moving unit from the front side of the liquid ejection apparatus by performing the pushing operation the operation shaft toward the rear side from the front side. Therefore, the convenience of the operator can be improved. In addition, when the moving unit is not operated, the power load on the moving unit can be reduced.
[7] In the liquid ejection apparatus, the cap may be a suction cap that suctions the liquid from the head while covering the nozzle surface. According to the configuration, the same effects as those in [1] can be achieved.
[8] In the liquid ejection apparatus, the cap may be a moisturizing cap that moisturizes the head by covering the nozzle surface. According to the configuration, the same effects as those in [1] can be achieved.
[9] In the liquid ejection apparatus, the cap may include a suction cap that suctions the liquid from the head while covering the nozzle surface, and a moisturizing cap that moisturizes the head by covering the nozzle surface,
the moving unit may include a first moving unit that moves the suction cap to a first cap position at which the suction cap covers the nozzle surface and a first separated position at which the suction cap is separated from the nozzle surface along the vertical direction, and a second moving unit that moves the moisturizing cap to a second cap position at which the moisturizing cap covers the nozzle surface and a second separated position at which the moisturizing cap is separated from the nozzle surface along the vertical direction, and the first moving unit and the second moving unit may be operable by the operator from the front side.

According to the configuration, it is not necessary to secure a work space at the lateral side of the liquid ejection apparatus, and the operator can operate both the first moving unit and the second moving unit from the front side of the liquid ejection apparatus. Therefore, the convenience of the operator can be improved.
[10] The liquid ejection apparatus further includes a wiping portion that wipes the nozzle surface, wherein the wiping portion may be located on an outer side of the cap in the first direction.

According to the configuration, even when the wiping portion is located on the outer side of the cap in the first direction, the operator can operate the moving unit that moves the cap from the front side of the liquid ejection apparatus. Therefore, the convenience of the operator can be improved.

What is claimed is:

1. A liquid ejection apparatus comprising:
a head having a nozzle surface in which a plurality of nozzles that eject a liquid are opened;
a carriage that moves along first direction intersecting vertical direction while supporting the head;
a cap that covers the nozzle surface; and
a moving unit that moves the cap along the vertical direction between a cap position at which the cap covers the nozzle surface and a separated position at which the cap is separated from the nozzle surface, wherein
the moving unit is operable by an operator from a front side along second direction intersecting the vertical direction and the first direction.

2. The liquid ejection apparatus according to claim 1, further comprising an operation shaft extending along the second direction, wherein
the operation shaft is operable by the operator from the front side and is engageable with the moving unit.

3. The liquid ejection apparatus according to claim 2, further comprising:
a medium support section that supports a medium onto which the liquid is ejected from the head; and
a cover that covers a part of the medium support section, wherein
the operation shaft is operable by the operator by opening the cover.

4. The liquid ejection apparatus according to claim 3, wherein
the medium support section has an insertion hole,
the insertion hole is covered by the cover, and
the operation shaft is operable by the operator from the front side via the insertion hole.

5. The liquid ejection apparatus according to claim 3, further comprising a knob engaged with the operation shaft, wherein
the medium support section has an insertion hole,
the knob is turnable when being inserted into the insertion hole,
the knob is covered by the cover, and
the operation shaft is operable by the operator by turning the knob.

6. The liquid ejection apparatus according to claim 2, wherein
the operation shaft is engageable with the moving unit when pushed toward a rear side from the front side.

7. The liquid ejection apparatus according to claim 1, wherein
the cap is a suction cap that suctions the liquid from the head while covering the nozzle surface.

8. The liquid ejection apparatus according to claim 1, wherein
the cap is a moisturizing cap that moisturizes the head by covering the nozzle surface.

9. The liquid ejection apparatus according to claim 1, wherein
the cap includes
a suction cap that suctions the liquid from the head while covering the nozzle surface, and
a moisturizing cap that moisturizes the head by covering the nozzle surface,
the moving unit includes
a first moving unit that moves the suction cap to a first cap position at which the suction cap covers the nozzle surface and a first separated position at which the suction cap is separated from the nozzle surface along the vertical direction, and
a second moving unit that moves the moisturizing cap to a second cap position at which the moisturizing cap covers the nozzle surface and a second separated position at which the moisturizing cap is separated from the nozzle surface along the vertical direction, and
the first moving unit and the second moving unit are operable by the operator from the front side.

10. The liquid ejection apparatus according to claim 1, further comprising a wiping portion that wipes the nozzle surface, wherein
the wiping portion is located on an outer side of the cap in the first direction.
